(19) United States
(12) Patent Application Publication
(10) Pub. No.: US 2007/0286458 A1
(43) Pub. Date: Dec. 13, 2007

(54) Method and System for Tracking a Target

(75) Inventor: Christine Podilchuk, Warren, NJ (US)

Correspondence Address: CATALINA & ASSOCIATES;A Professional Corporation, 2355 HIghway 33, Robbinsville, NJ, 08691, US

(73) Assignee: D&S CONSULTANTS, INC., Eatontown, NJ (US)

(21) Appl. No.: 11/619,083

(22) Filed: Jan. 2, 2007

Related U.S. Application Data
(60) Provisional application No. 60/812,646, filed on Jun. 12, 2006.
(60) Provisional application No. 60/816,686, filed on Jun. 27, 2006.
(60) Provisional application No. 60/861,685, filed on Nov. 29, 2006.
(60) Provisional application No. 60/861,932, filed on Nov. 30, 2006.
(60) Provisional application No. 60/873,179, filed on Dec. 6, 2006.

(51) Int. Cl. G06K 9/00

(52) U.S. Cl. 382/103

(57) ABSTRACT

A method and system for tracking one or more targets are described. The method includes the step of selecting a first template having a first image of a target and cyclically repeated steps of accumulating new images of the target, producing updated templates containing the new images, and tracking the target using the updated templates. Embodiments of the method use techniques directed to detection and mitigation of target occlusion events.

### CROSS-REFERENCE TO RELATED APPLICATIONS

This application claims benefit of U.S. provisional patent application Ser. No. 60/814,611, filed by C. Podilchuk on Jun. 16, 2006 entitled “Target tracking using adaptive target updates and occlusion detection and recovery”, which is herein incorporated by reference.

### FIELD OF THE INVENTION

The present inventions generally relates to the field of electronic surveillance and, in particular, to a method and system for tracking targets.

### BACKGROUND OF THE INVENTION

Target tracking is used by military, law enforcement, commercial, and private entities. The goal of target tracking is recognition and then monitoring of one or more objects of interest (referred to herein as “targets”) in video data sequences produced by respective surveillance apparatus(es). In applications, target tracking is performed in a real time or, alternatively, using pre-recorded surveillance data.

Main challenges in the field of target tracking relate to identification of targets that change their appearance due to motion, orientation in 3D space, or temporary occlusion by other objects. Despite the considerable effort in the art devoted to methods and systems for tracking targets, further improvements would be desirable.

### SUMMARY OF THE INVENTION

One aspect of the invention provides a method for tracking one or more targets. The method includes the step of selecting a first template having a first image of a target and a plurality of cyclically repeated steps of accumulating current images of the target, producing updated templates, and tracking the target using the updated templates. In one embodiment, the updated template is generated if the target is recognized using the first or previously updated template; otherwise these templates are adopted as the updated templates. In further embodiments, the method uses techniques directed to recovery from tracking failures and mitigation of target occlusion events.

Another aspect of the present invention provides a system using the inventive method for tracking one or more targets.

Various other aspects and embodiments of the invention are described in further detail below.

The Summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 is a flow diagram illustrating a method for tracking at least one target in accordance with one embodiment of the present invention.

FIG. 2 is a high-level, schematic diagram of an exemplary system using the method of FIG. 1.

To facilitate understanding, identical reference numerals have been used, where possible, to designate identical elements that are common to the figures. The images in the drawings are simplified for illustrative purposes and are not depicted to scale.

The appended drawings illustrate exemplary embodiments of the invention and, as such, should not be considered as limiting the scope of the invention that may admit to other equally effective embodiments. It is contemplated that features or steps of one embodiment may beneficially be incorporated in other embodiments without further recitation.

### DETAILED DESCRIPTION

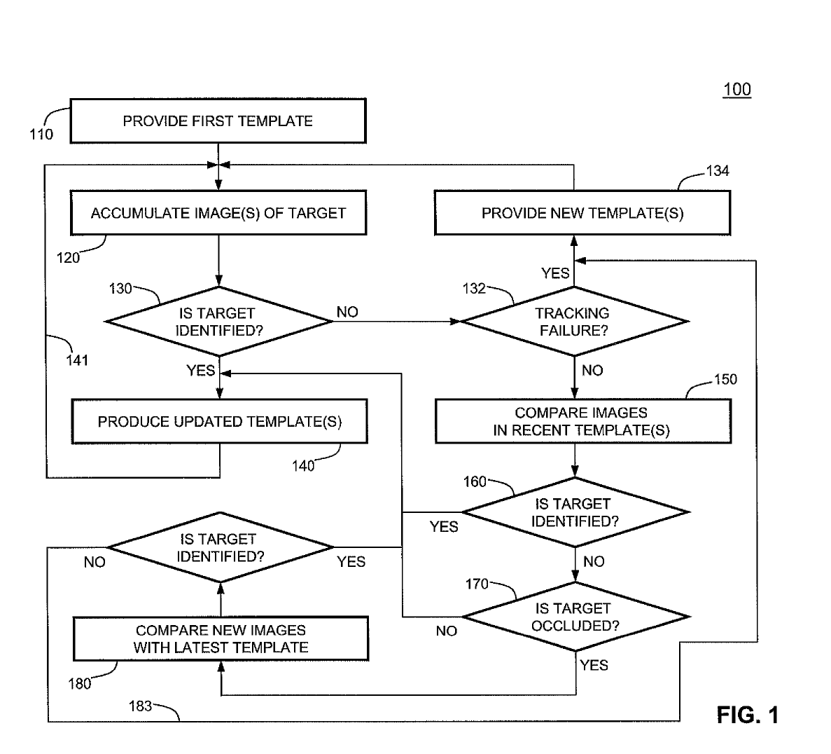

Referring to the figures, FIG. 1 depicts a flow diagram illustrating a method 100 for tracking at least one target in accordance with one embodiment of the present invention.

Hereafter, aspects of the present invention are illustratively described within the context of live targets (for example, humans, animals, or body parts thereof) or material objects, which movements are monitored in the respective conventional habitats, conditions, or environment.

The invention may also be utilized within the context of other types of targets, such as missiles or their plumes (for example, reactive propelled grenades (RPGs), ballistic or cruise missiles, among other missiles), beams of laser light, objects floating in air, free space, in liquid or on a surface of liquid, and the like. It has been contemplated and is within the scope of the invention that the method 100 is utilized within the context of such targets.

In various embodiments, method steps of the method 100 are performed in the depicted order or at least two of these steps or portions thereof may be performed contemporaneously, in parallel, or in a different order. For example, portions of steps 120 and 130 may be performed contemporaneously or in parallel. Those skilled in the art will readily appreciate that the order of executing at least a portion of other discussed below processes or routines may also be modified.

In application, a plurality of targets may similarly be tracked using processing steps of the method 100 that is illustratively discussed below in reference to a single target.

At step 110, an initial, or first, template having an image of a target in provided or generated. The initial template is generally a video file that contains, in a pre-determined digital electronic format, the image of the target operating or disposed in a particular environment. Images of the target available a form of a photographic image, a picture, a sketch, or the like target-identifying imagery are digitized (for example, scanned) and converted in the pre-determined electronic format.

At step 120, a respective surveillance monitor (for example, digital video camera) starts accumulating, at a pre-determined sampling rate, images of a monitored region where the target may appear or be present. When the surveillance monitor provides output information in an analog form, such information is subsequently digitized. In one embodiment, accumulated images are converted in the pre-determined digital electronic format used in the initial template or, alternatively, the pre-determined digital electronic format is an electronic format used in the surveillance monitor.

At step 130, the method 100 queries if the target is identified in a particular accumulated image. If the query of step 130 is affirmatively answered, the method 100 proceeds to step 140, where that accumulated image is adopted as an updated template, which replaces the initial template of step 110.

Steps 120, 130, and 140 are cyclically repeated (shown with a link 141) and, in each cycle, a preceding template is updated with the template having an image of the target that, during a surveillance process, is concurrently updated. Such concurrent updates allow to track targets, which images are changing over time and, as such, increase probability of recognizing the targets. In real-time surveillance applications, a rate of accumulating new images (i.e., sampling rate) and a rate of updating the templates should be sufficiently high to monitor changes in appearance of moving or evolving targets.

Previously used, or historic, templates are selectively saved and may be used to mitigate tracking failures, as discussed below in reference to steps 132, 170, and 182. To reduce tracking errors, during step 130, a current (i.e., most recent) image of the target may also be compared with its images in one or more templates produced during the preceding cycles (i.e., historic templates).

If the query of step 130 is negatively answered, the method 100 proceeds to step 132, where the method 100 queries if there is a tracking failure. The tracking failure is identified as en event when the target is not identified for a pre-determined duration of time.

If the query of step 132 is affirmatively answered, the method 100 proceeds to step 134, where one or more new templates containing other available image of the target, including historic templates, are provided. In some embodiments, the new and initial templates may be used together to analyze images accumulated during previous or consequent steps 120. Alternatively, a new template may replace the initial template.

If the query of step 132 is negatively answered, the method 100 proceeds to step 150. At step 150, to increase probability of target recognition, in addition to a latest image of the monitored region, other recent images of the region are compared with one or more recently updated or historic templates.

At step 160, the method 100 queries if the target is identified in at least one of the latest or recent images of the monitored region. If the query of step 160 is affirmatively answered, the method 100 proceeds to step 140, where a template that was used to identify the target during step 150, is adopted as the updated template. The affirmative answer to the query of step 160 indicates that the method 100 has recovered from a temporal loss of the target.

If the query of step 160 is negatively answered, the method 100 proceeds to step 170, where the method queries if, in the monitored region, the target has become occluded.

When the target is occluded, its image contains a mixture of regions having, versus the most recent template, matching errors that are smaller than a first pre-determined threshold τ1 (referred to as “small matching errors”) or greater than the second pre-determined threshold τ2 (referred to as “large matching errors”). Generally, the small matching errors reflect changes resulting from target's motion or re-orientation, whereas the large matching errors are indicative of an occlusion of the target.

Occlusion of the target is detected when the following condition is met:

$$( {\sum }_{e = τ 1}^{1} P ( e ) ) \geq τ 2 , \qquad ( 1 )$$

where e is an error image of a target match with a respective template, and P(e) is a histogram of the error image filtered using a smoothening filter. The smoothening filter uses a recursive data processing algorithm and, in one embodiment, is the Kalman filter.

The threshold τ1 is a normalized error threshold that defines sensitivity of an occlusion detection process and, when is exceeded, indicates that pixels in an error block of the analyzed image are pixels of erroneous regions. A low value of the threshold τ1 corresponds to high sensitivity of the occlusion detection process. In most applications, a value of the threshold τ1 may be selected in a range of about 0.2-0.3.

The threshold τ2 is a pixel frequency threshold. When, in a pixel block, a number of pixels exceeding the threshold τ1 also exceeds the threshold τ2, that indicates an occlusion event in the respective pixel block. A high value of the threshold τ2 corresponds to a greater delay in detection of the occlusion event or probability of using a faulty (i.e., outdated) template. Generally, a value of may be selected in a range of about 0.4-0.6. If the query of step 170 is affirmatively answered (i.e., occlusion of the target has been detected), the method 100 proceeds to step 180, where new accumulated images of the monitored region are compared, during a pre-determined time interval, with the latest updated template.

At step 182, the method 100 queries if, during step 180, the target is identified. If the query of step 182 is affirmatively answered, the method 100 proceeds to step 140, where the template used to identify the target is re-instated as the updated template.

If the query of step 182 is negatively answered, the method 100 proceeds to step 134 (shown with a link 183). In one embodiment, new accumulated images are compared with all available prior templates until the target is recognized. Alternatively, if the target is not recognized during a specific time interval, target monitoring may be terminated.

In exemplary embodiments, the method 100 may be implemented in hardware, software, firmware, or any combination thereof in a form of a computer program product comprising computer-executable instructions. When implemented in software, the computer program product may be stored on or transmitted using a computer-readable medium adapted for storing the instructions or transferring the computer program product from one computer to another.

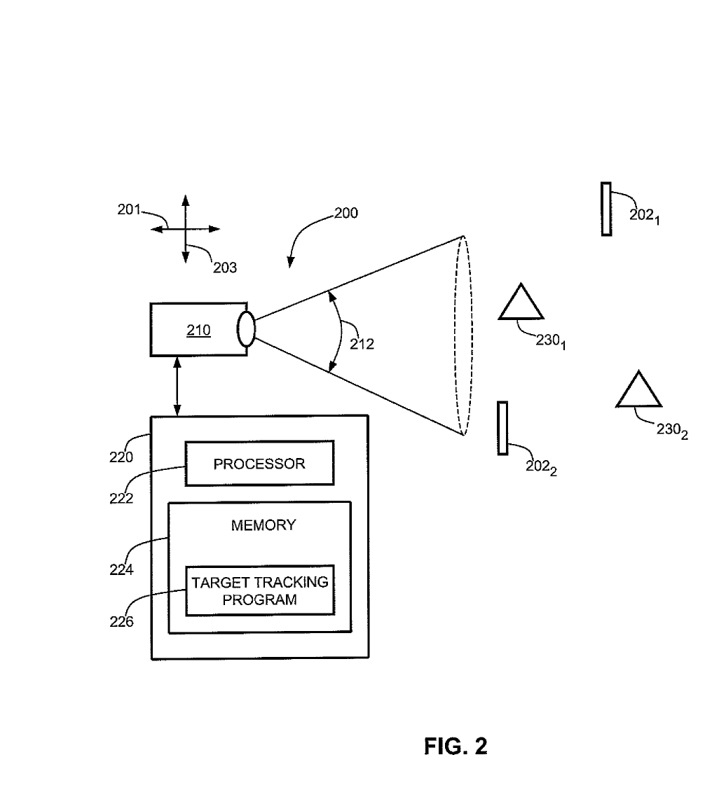

FIG. 2 is a high-level, schematic diagram of an exemplary system 200 using the method 100. To best understand the invention, the reader is suggested to refer to FIGS. 1-2 simultaneously.

The system 200 illustratively includes at least one surveillance monitor 210 (one surveillance monitor is shown), and an analyzer 220 of data provided by the monitor 210. In one exemplary embodiment, the surveillance monitor 210 is a digital video-recording device, and the analyzer 220 is a computer having a processor 222 and a memory 224.

The memory 224 contains a target-tracking software, or program, 226 encoding, in a form of computer instructions, the method 100. When executed by the processor 222, the program 226 executes processing steps of the method 100. In some embodiments, the analyzer 220 is disposed remotely from the surveillance monitor(s) 210. Alternatively, the analyzer 220 may be a portion of the surveillance monitor.

The surveillance monitor 210 has a 3D viewing field 212 that determines boundaries of a monitored region of the system 200. To increase the monitored region, the surveillance monitor 210 or the viewing field 212 may be rotated, or scanned, about horizontal and vertical axes 201, 203. Typically, surveillance monitor 210 produces images, or frames, of the monitored region at a rate of about 10 to 100 images per second.

In the depicted embodiment, a plurality of exemplary targets 230 and objects 202 are disposed in the viewing field 212 of the surveillance monitor 210 (targets 230₁, 230₂ and objects 202₁, 202₂ are shown). Both the targets 230 and objects 202 may move in 3D space and, occasionally, the objects 202 may occlude, partially or entirely, one or more targets 230 or some targets may occlude other targets.

Although the invention herein has been described with reference to particular illustrative embodiments, it is to be understood that these embodiments are merely illustrative of the principles and applications of the present invention. Therefore numerous modifications may be made to the illustrative embodiments and other arrangements may be devised without departing from the spirit and scope of the present invention, which is defined by the appended claims.

What is claimed is:

1. A method of tracking a target, comprising:
(a) selecting a first template for the target having a first image of the target;
(b) accumulating a current image of the target;
(c) generating an updated template for the target; and
(d) tracking the target using the updated template.

2. The method of claim 1, wherein the step (c) further comprises:
generating the updated template if, using the first template, the target is recognized;
adopting the first template as the updated template if, using the first template, the target is not recognized.

4. The method of claim 1, further comprising:
cyclically repeating the steps (b)-(d);
generating the updated template if the target is recognized using a previously updated template; and
using the previously updated template as the updated template if, using the previously updated template, the target is not recognized.

5. The method of claim 4, wherein the step (b) further comprises:
storing the previously updated templates as historic templates of the target.

6. The method of claim 5, wherein the step (d) further comprises:
(d1) comparing the current image and consequent images of the target with images of the target in the historic templates if the target is not recognized on a most recent of the updated templates; and
(d2) selecting a template allowing to recognize the target as the updated template.

7. The method of claim 6, wherein the step (d1) further comprises:
accumulating the consequent images of the target for a pre-determined duration of time.

8. The method of claim 6, wherein the step (d2) further comprises:
selecting the first template as the updated template if the target is not recognized.

9. The method of claim 6, further comprising:
detecting an occlusion of the target if a condition
$$( {\sum }_{e = τ 1}^{1} P ( e ) ) \geq τ 2$$
is detected,
wherein e is an error image of a target match with a template, P(e) is a histogram of the error image, and τ1 and τ2 are pre-determined thresholds.

10. The method of claim 9, wherein the threshold τ1 is selected in a range of about 0.2-0.3 and the threshold τ2 is selected in a range of about ______-______.

11. The method of claim 9, wherein the error image e is filtered using a smoothening filter.

12. The method of claim 11, wherein the smoothening filter uses a recursive data processing algorithm.

13. The method of claim 12, wherein the smoothening filter is the Kalman filter.

14. The method of claim 1, further comprising:
selectively tracking multiple targets of a plurality of the targets.

15. An apparatus executing the method of claim 1.

16. A system for tracking a target, comprising:
at least one surveillance monitor; and
an analyzer of data provided by the surveillance monitor, the analyzer adapted to execute software having instructions causing the analyzer to perform the steps of:
(a) selecting a first template for the target having a first image of the target;
(b) accumulating a current image of the target;
(c) generating an updated template for the target; and
(d) tracking the target using the updated template.

17. The system of claim 16, wherein said system is adapted for tracking multiple targets of a plurality of the targets.

18. The system of claim 16, wherein the least one surveillance monitor comprises a video-recording device.

19. The system of claim 16, wherein the analyzer comprises a memory containing the instructions and a processor executing the instructions.

20. The system of claim 16, wherein the analyzer is disposed remotely from the at least one surveillance monitor.

21. The system of claim 16, wherein the analyzer is a portion of the at least one surveillance monitor.

22. The system of claim 16, wherein the analyzer is further adapted to perform the steps of:
generating the updated template if, using the first template, the target is recognized;
adopting the first template as the updated template if, using the first template, the target is not recognized.

23. The system of claim 16, wherein the analyzer is further adapted to perform the steps of:
cyclically repeating the steps (b)-(d);
generating the updated template if the target is recognized using a previously updated template; and
using the previously updated template as the updated template if, using the previously updated template, the target is not recognized.

24. A computer readable medium storing software that, when executed by a processor, causes a system for tracking a target to perform a method, comprising:
(a) selecting a first template for the target having a first image of the target;
(b) accumulating a current image of the target;
(c) generating an updated template for the target; and
(d) tracking the target using the updated template.

25. The computer readable medium of claim 24, wherein the step (c) further comprises:
generating the updated template if, using the first template, the target is recognized;
adopting the first template as the updated template if, using the first template, the target is not recognized.

26. The computer readable medium of claim 24, further comprising:
cyclically repeating the steps (b)-(d);
generating the updated template if the target is recognized using a previously updated template; and
using the previously updated template as the updated template if, using the previously updated template, the target is not recognized.

27. The computer readable medium of claim 26, wherein the step (b) further comprises:
storing the previously updated templates as historic templates of the target.

28. The computer readable medium of claim 27, wherein the step (d) further comprises:
(d1) comparing the current image and consequent images of the target with images of the target in the historic templates if the target is not recognized on a most recent of the updated templates; and
(d2) selecting a template allowing to recognize the target as the updated template.

29. The computer readable medium of claim 28, wherein the step (d1) further comprises:
accumulating the consequent images of the target for a pre-determined duration of time.

30. The computer readable medium of claim 28, wherein the step (d2) further comprises:
selecting the first template as the updated template if the target is not recognized.

31. The computer readable medium of claim 28, further comprising:
detecting an occlusion of the target if a condition
$$( {\sum }_{e = τ 1}^{1} P ( e ) ) \geq τ 2$$
is detected,
wherein e is an error image of a target match with a template, P(e) is a histogram of the error image, and τ1 and τ2 are pre-determined thresholds.

32. The computer readable medium of claim 31, wherein the threshold τ1 is selected in a range of about 0.2-0.3 and the threshold τ2 is selected in a range of about 0.4-0.6.

33. The computer readable medium of claim 31, wherein the error image e is filtered using the Kalman filter.

34. The computer readable medium of claim 24, further comprising:
selectively tracking multiple targets of a plurality of the targets.
